(19) United States
(12) Patent Application Publication
(10) Pub. No.: US 2025/0122087 A1
(43) Pub. Date: Apr. 17, 2025

(54) Purification method and system for lithium-extraction dissolving-solution of aluminum electrolysis waste

(71) Applicant: ZHENGZHOU NON-FERROUS METALS RESEARCH INSTITUTE CO.LTD OF CHALCO, Zhengzhou (CN)

(72) Inventors: Kaibin CHEN, Zhengzhou (CN); Tingting DU, Zhengzhou (CN); Haiwen WU, Zhengzhou (CN); Jianjun LIU, Zhengzhou (CN); Ruonan LI, Zhengzhou (CN); Zhongsheng LUO, Zhengzhou (CN); Xun WANG, Zhengzhou (CN); Lizhen SUN, Zhengzhou (CN); Jianwei WU, Zhengzhou (CN); Quanhai JING, Zhengzhou (CN)

(73) Assignee: ZHENGZHOU NON-FERROUS METALS RESEARCH INSTITUTE CO.LTD OF CHALCO, Zhengzhou, HE (CN)

(21) Appl. No.: 19/000,581

(22) Filed: Dec. 23, 2024

Related U.S. Application Data
(63) Continuation of application No. PCT/CN2024/071105, filed on Jan. 8, 2024.

(30) Foreign Application Priority Data
May 12, 2023 (CN) 202310546111.1

(51) Int. Cl. C01D 15/08; B01D 29/01; B01D 29/64; B01D 29/94

(52) U.S. Cl. CPC C01D 15/08; B01D 29/01; B01D 29/6476; B01D 29/94

(57) ABSTRACT

A purification method and system for a lithium-extraction dissolving-solution of an aluminum electrolysis waste, the method includes: adding an alkaline mixture to the lithium-extraction dissolving-solution until a pH of the lithium-extraction dissolving-solution reaches a first target pH, and filtering the lithium-extraction dissolving-solution to obtain a first filtrate after performing a first reaction in the lithium-extraction dissolving-solution; the first target pH is 11.5˜12; and adding a decalcification agent and a catalyst to the first filtrate until a pH of the first filtrate reaches a second target pH, and filtering the first filtrate to obtain a purified dissolving-solution after performing a second reaction in the first filtrate, the second target pH being 11.5˜12.

### CROSS-REFERENCE TO RELATED APPLICATIONS

This is a continuation of International Application No. PCT/CN2024/071105 filed on Jan. 8, 2024, which claims priority to Chinese patent application No. 202310546111.1 filed on May 12, 2023. The disclosures of the above-referenced applications are hereby incorporated by reference in their entirety.

### BACKGROUND

An aluminum electrolysis waste is a waste generated during a production process for electrolytic aluminum. Since most of current alumina raw materials produced in Shan Xi and He Nan and so on in China contain lithium elements, during an operation of an electrolytic cell, the lithium elements are continuously enriched in an electrolyte and penetrated into a cathode and lining of the electrolytic cell, resulting in a continuously increased lithium content in the electrolyte and the lining of the electrolytic cell. When the electrolytic cell is damaged, the cathode and lining need to be completely replaced, and the resulting large amount of waste is an overhaul slag. The overhaul slag has a high lithium content, and the remaining electrolyte also has a high lithium content. At the same time, as a lithium carbonate has currently a high price, there is an increasing number of researches on extracting the lithium from the aluminum electrolysis waste and preparing lithium carbonate products.

Existing technology for extracting the lithium from the aluminum electrolysis waste and preparing the lithium carbonate products mainly focuses on a dissolution process of lithium salts, while there are not sufficiently detailed records about a key purification process of a lithium-extraction dissolving-solution, most of which are too simple. In addition, types of impurities removed are relatively few and not complete. At the same time, a loss rate of lithium is too high, so that a recovery rate of the lithium carbonate products is too low. Therefore the existing technology is difficult to be used in practice. Therefore, how to comprehensively remove impurities in the lithium-extraction dissolving-solution under a premise of low loss rate of lithium is a technical problem that needs to be solved urgently.

### SUMMARY

The disclosure relates to the field of recycling of an aluminum electrolysis waste, and in particular to a method and system for purifying a lithium-extraction dissolving-solution of the aluminum electrolysis waste.

The disclosure discloses a purification method and system for a lithium-extraction dissolving-solution of an aluminum electrolysis waste, so as to solve technical problems in some implementations that it is difficult to comprehensively remove impurities in the lithium-extraction dissolving-solution under a premise of low loss of lithium rate.

In a first aspect, a purification method for a lithium-extraction dissolving-solution of an aluminum electrolysis waste is provided according to an embodiment of the disclosure, the method includes: adding an alkaline mixture to the lithium-extraction dissolving-solution until a pH of the lithium-extraction dissolving-solution reaches a first target pH and performing a first reaction in the lithium-extraction, and then filtering the lithium-extraction dissolving-solution to obtain a first filtrate; wherein the alkaline mixture comprises a regulator and a stabilizer, and the regulator is added into the lithium-extraction dissolving-solution after the stabilizer is added into the lithium-extraction; the stabilizer comprises a calcium sulfate; the regulator comprises a calcium oxide and/or a calcium hydroxide; the first target pH is 11˜11.5; and adding a decalcification agent and a catalyst to the first filtrate until a pH of the first filtrate reaches a second target pH and performing a second reaction in the first filtrate, and then filtering the first filtrate to obtain a purified dissolving-solution, the second target pH being 11.5˜12.

In a second aspect, a purification method for a lithium-extraction dissolving-solution of an aluminum electrolysis waste is provided according to an embodiment of the disclosure, the method includes: adding an alkaline mixture to the lithium-extraction dissolving-solution until a pH of the lithium-extraction dissolving-solution reaches a first target pH and performing a first reaction in the lithium-extraction dissolving-solution, and then filtering the lithium-extraction dissolving-solution to obtain a first filtrate and a first filter residue, respectively; in which the alkaline mixture comprises a regulator and a stabilizer, and the regulator is added into the lithium-extraction dissolving-solution after the stabilizer is added into the lithium-extraction; the stabilizer comprises a calcium sulfate, and the regulator comprises a calcium oxide and/or a calcium hydroxide; and the first target pH is 11˜11.5; and adding a decalcification agent and a catalyst into the first filtrate until a pH of the first filtrate reaches a second target pH and performing a second reaction in the first filtrate, and then filtering the first filtrate to obtain a purified dissolving-solution and a second filter residue, respectively; and washing the first filter residue and the second filter residue by adding a washing liquid into the first filter residue and the second filter residue to form a washing slurry, and then filtering the washing slurry to obtain a washing filtrate, and returning the washing filtrate into the lithium-extraction dissolving-solution for a treatment.

In the third aspect, a purification system for an lithium-extraction dissolving-solution of an aluminum electrolysis waste is further provided according to embodiments of the disclosure, the system being adapted to the above method, the system including at least two purification devices, the purification device including: a filter unit, which includes a liquid-reception tray, a stir motor, a scraper and a filter screen; the filter screen is disposed at a bottom surface of the liquid-reception tray; an output end of the stir motor is connected to the scraper, and the scraper is disposed above the filter screen; and a liquid-reception unit, which includes a liquid-reception tank, a vacuum interface, a feed port, a discharge port and a stir paddle; the liquid-reception tank is disposed directly below the filter screen; the feed port and the discharge port are respectively distributed on two sides of the liquid-reception tank, and the vacuum interface and the discharge port are disposed on a same side of the liquid-reception tank; the stir paddle is disposed in the liquid-reception tank, and the stir paddle is fixedly connected to an extended end of the stir motor.

### BRIEF DESCRIPTION OF DRAWINGS

The accompanying drawings, which are incorporated in and constitute a portion of this specification, and illustrate some embodiments consistent with the disclosure and serve to explain principles of the disclosure together with the description.

In order to more clearly illustrate the embodiments of the disclosure or the technical solutions in some implementations, the accompanying drawings needed to be used in the description of the embodiments or some implementations will be briefly introduced below. Obviously, for those skilled in the art, other accompanying drawings can also be obtained based on these accompanying drawings without creative efforts.

FIG. 1 is a schematic flow diagram of a purification method for a lithium-extraction dissolving-solution of an aluminum electrolysis waste according to some embodiments of the disclosure;

FIG. 2 is a detailed schematic flow diagram of a purification method for a lithium-extraction dissolving-solution of an aluminum electrolysis waste according to some embodiments of the disclosure;

FIG. 3 is a schematic flow diagram of a purification method for a lithium-extraction dissolving-solution of an aluminum electrolysis waste according to other embodiments of the disclosure; and

FIG. 4 is a schematic structural diagram of a purification device for a lithium-extraction dissolving-solution of an aluminum electrolysis waste according to some embodiments of the disclosure.

Reference numerals: 1, filter unit; 11, liquid-reception tray; 12, stir motor; 13, scraper; 14, filter screen; 2, liquid-reception unit; 21, liquid-reception tank; 22, vacuum interface; 23, feed port; 24, discharge port; 25, stir paddle; 3, residue discharge unit; 31, shovel truck; 32, shovel-truck lane; 33, filter residue groove; 34, shovel-truck baffle.

### DETAILED DESCRIPTION

In order to make purposes, technical solutions and advantages of the embodiments of the disclosure clearer, the technical solutions in the embodiments of the disclosure will be clearly and completely described below in conjunction with the accompanying drawing according to the embodiments of the disclosure. Obviously, the described embodiments are some embodiments of the disclosure, but not all embodiments. Based on the embodiments in the disclosure, all other embodiments obtained by those skilled in the art without any creative efforts fall within the scope of protection sought by the disclosure.

Unless otherwise specified, various raw materials, reagents, instruments, and equipment used in the disclosure are commercially available or obtained through existing methods.

Existing technology for extracting a lithium from an aluminum electrolysis waste and preparing lithium carbonate products mainly focuses on a dissolution process of lithium salts, including that:

(1) a water-soluble inorganic salt is added to an electrolyte to leach a lithium salt out after the electrolyte is heat treated. After the lithium salt is leached out, the electrolyte is filtered to obtain a filtrate B, and then an alkali (a sodium hydroxide or a potassium hydroxide) or an aqueous solution of the alkali is added to the filtrate B to remove aluminum ions in the filtrate B. The filtrate B is then filtered to obtain a filtrate C, and a carbonate is added to the filtrate C to obtain a precipitation of lithium carbonate.

(2) the electrolyte is subjected to an acidification reaction with a nitric acid, and the electrolyte after the acidification reaction is filtered to obtain a filtrate. The filtrate is treated a plurality of times to obtain a sodium nitrate, a calcium fluoride and lithium salt products, and “a soluble calcium salt or a calcium hydroxide is added to a tertiary filtrate to remove fluoride ions in the filtrate, and then the tertiary filtrate is filtered to obtain a fourth filtrate and a precipitation of calcium fluoride, and an oxalic acid is added into the fourth filtrate to precipitate excess calcium ions.”

(3) a lithium-containing waste is crushed, and then an inorganic acid solution is added into the crushed lithium-containing waste to make a lithium fluoride and the like in the lithium-containing waste to react with the inorganic acid solution, and a product after the reaction is filtered to obtain a filtrate D. A sodium bicarbonate is added into the filtrate D to remove an iron in the filtrate D, and then the filtrate D is filtered to obtain a filtrate E. The sodium hydroxide is added into the filtrate E to remove an aluminum in the filtrate E, and then the filtrate E is filtered to obtain a filtrate F. A sodium oxalate is added into the filtrate F to remove a cobalt in the filtrate F, and then the filtrate F is filtered to obtain a filtrate G, and then a sodium carbonate is added into the filtrate G to precipitate and obtain the lithium carbonate.

Components of the aluminum electrolysis waste mainly include the electrolyte, a carbon slag and an overhaul slag. Main components of the electrolyte are Na₃AlF₆, the calcium fluoride, an aluminum oxide, K₂NaAlF₆, LiNa₂AlF₆ and LiF. Components of the overhaul slag is relatively complex, and mainly include a carbon, an aluminum silicon, a sodium fluoride, the calcium fluoride, the lithium fluoride, a cryolite and the iron and the like. The main components of the carbon slag are the carbon and the electrolyte.

At present, technologies for extracting a lithium from an aluminum electrolysis waste in industry mainly include three types: first is direct acid leaching, second is acid leaching or salt leaching after roasting, and third is salt leaching. No matter which type of the above technologies is used to extract the lithium, the lithium-extraction dissolving-solution will inevitably contain impurity elements except for the lithium. The impurity elements mainly include fluorine, calcium, magnesium, iron, aluminum, boron, silicon, manganese, nickel and copper and so on. These impurity elements are required to be removed to ensure a purity of final lithium carbonate product.

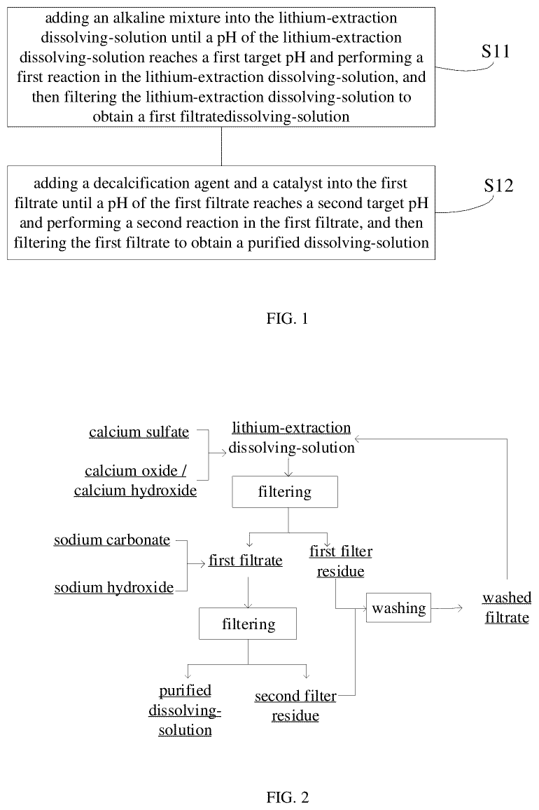

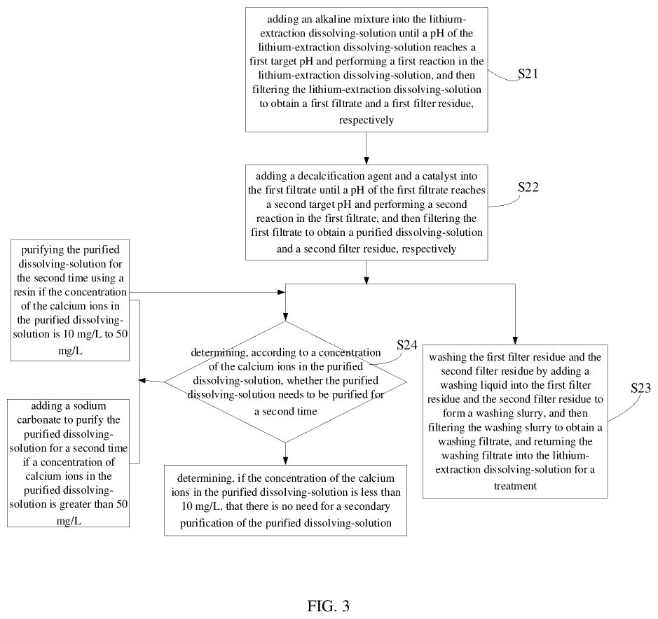

As shown in FIG. 1, a purification method for a lithium-extraction dissolving-solution of an aluminum electrolysis waste is provided according to an embodiment in a first aspect of the disclosure. The method includes:

Step S11, adding an alkaline mixture into the lithium-extraction dissolving-solution until a pH of the lithium-extraction dissolving-solution reaches a first target pH and performing a first reaction in the lithium-extraction dissolving-solution, and then filtering the lithium-extraction dissolving-solution to obtain a first filtrate; and

Step S12, adding a decalcification agent and a catalyst into the first filtrate until a pH of the first filtrate reaches a second target pH and performing a second reaction in the first filtrate, and then filtering the first filtrate to obtain a purified dissolving-solution.

In one or more embodiments, the first target pH is 11-11.5, and the second target pH is 11.5-12.

The first target pH is controlled as 11-11.5 by adding an alkaline mixture (such as a stabilizer and a regulator), on the one hand, lithium ions in the lithium-extraction dissolving-solution can be stabilized so that the lithium ions exist in a stable and highly soluble form. On the other hand, a pH of the lithium-extraction dissolving-solution is adjusted as 11˜11.5, such that fluoride ions, iron ions, aluminum ions, boron ions, silicon ions, manganese ions, nickel ions, copper ions and a portion of magnesium ions and so on in the lithium-extraction dissolving-solution can be effectively removed to ensure that a concentration of fluoride ions in the lithium-extraction dissolving-solution is below 10 mg/L, and concentrations of other impurity ions are close to or equal to 0.

The second target pH is controlled as 11.5-12 by adding the decalcification agent and the catalyst, such that the calcium ions and magnesium ions in the first filtrate can be effectively removed.

In some embodiments, the alkaline mixture includes a regulator and a stabilizer, and the regulator is added into the lithium-extraction dissolving-solution after the stabilizer is added into the lithium-extraction dissolving-solution.

In some embodiments, the stabilizer includes a calcium sulfate, and the regulator includes a calcium oxide and/or a calcium hydroxide.

In addition to the lithium, the lithium-extraction dissolving-solution also contains impurities such as the fluoride ions, the iron ions, the aluminum ions, the boron ions, the silicon ions, the manganese ions, the nickel ions, the copper ions and a portion of the magnesium ions and so on. In the first reaction of the lithium-extraction dissolving-solution, on the one hand, adding the calcium sulfate to the lithium-extraction dissolving-solution can stabilize the lithium ions in the lithium-extraction dissolving-solution, making the lithium ions exist in a form of stable and highly soluble lithium sulfate, thereby avoiding a loss of lithium. On the other hand, the pH of the lithium-extraction dissolving-solution is adjusted as 11˜11.5 by adding the calcium oxide and/or the calcium hydroxide to the lithium-extraction dissolving-solution, such that the fluoride ions, the iron ions, the aluminum ions, the boron ions, the silicon ions, the manganese ions, the nickel ions, the copper ions and a portion of magnesium ions and so on in the lithium-extraction dissolving-solution can be effectively removed to ensure that the concentration of fluoride ions in the lithium-extraction dissolving-solution is below 10 mg/L, and the concentrations of other impurity ions are close to or equal to 0.

In some embodiments, an addition amount of the stabilizer makes a mass volume ratio of the stabilizer to the lithium-extraction dissolving-solution to be 6 kg/m³ to 10 kg/m³; and/or, an addition amount of the regulator is an amount that makes the pH of the lithium-extraction dissolving-solution reach the first target pH.

Addition amounts of the stabilizer and regulator are controlled, on the one hand, the lithium ions in the lithium-extraction dissolving-solution can be stabilized so that the lithium ions exist in the form of stable and highly soluble lithium sulfate. On the other hand, the fluoride ions, the iron ions, the aluminum ions, the boron ions, the silicon ions, the manganese ions, the nickel ions, the copper ions and a portion of magnesium ions and so on in the lithium-extraction dissolving-solution can be effectively removed to ensure that the concentration of the fluoride ions in the lithium-extraction dissolving-solution is below 10 mg/L, and the concentrations of other impurity ions are close to or equal to 0.

In some embodiments, the decalcification agent includes a sodium carbonate. An actual addition amount of the sodium carbonate is 1.5 to 3.0 times a theoretical addition amount of the sodium carbonate. The theoretical addition amount of the sodium carbonate is determined by a concentration of the calcium ions in the first filtrate.

In some embodiments, the catalyst includes a sodium hydroxide. An addition amount of the sodium hydroxide makes a mass volume ratio of the sodium hydroxide to the first filtrate to be 0.2 kg/m³ to 0.5 kg/m³.

By controlling addition amounts of the decalcification agent and the catalyst, the lithium ions in the first filtrate will not be combined with a carbonate after the sodium carbonate is added, thereby avoiding the loss of lithium. Even if a small amount of the lithium ions combine with the carbonate, the lithium ions and carbonate will be separated after the sodium hydroxide as the catalyst is added, and the carbonate will combine with a calcium to further remove the calcium ions. The lithium ions are free in the first filtrate, thereby avoiding the loss of lithium.

A specific principle for decalcification and catalysis is that: according to solution dynamics, a combining tendency of a sodium with the carbonate is greater than that of the lithium with the carbonate. After the decalcification agent is added, the calcium ions in the first filtrate preferentially combine to the carbonate in the first filtrate to perform a decalcification reaction. In a condition that the lithium ions combine with the carbonate to form a lithium carbonate in the first filtrate after the decalcification agent is added, the sodium hydroxide as the catalyst is added to make the pH of the first filtrate reach the second target pH, such that the lithium ions are separated from the carbonate, and the carbonate combines with the calcium to further remove the calcium ions to form the sodium carbonate.

In some embodiments, a time for the first reaction is 30 to 60 minutes after the pH of the lithium-extraction dissolving-solution reaches the first target pH.

In some embodiments, the second reaction includes a decalcification reaction and a catalytic reaction; and the decalcification reaction is performed for 20 to 30 minutes, and then the catalytic reaction is performed for 20 to 30 minutes. The catalytic reaction is a catalytic decalcification reaction.

The fluoride ions, the magnesium ions, the iron ions, the aluminum ions, the boron ions, the silicon ions, the manganese ions, the nickel ions and the copper ions and so on in the lithium-extraction dissolving-solution can be effectively removed by controlling the time for the first reaction.

The calcium ions, the magnesium ions and the like in the first filtrate can be effectively removed by controlling the time for the second reaction.

In some embodiments, the method further includes:
Determining, according to a concentration of the calcium ions in the purified dissolving-solution, whether the purified dissolving-solution needs to be purified for a second time;
Determining, if the concentration of the calcium ions in the purified dissolving-solution is less than 10 mg/L, that there is no need for a secondary purification of the purified dissolving-solution;
adding the sodium carbonate to purify the purified dissolving-solution for the second time if the concentration of the calcium ions in the purified dissolving-solution is greater than 50 mg/L; and
purifying the purified dissolving-solution for the second time using a resin if the concentration of the calcium ions in the purified dissolving-solution is 10 mg/L to 50 mg/L.

The reason to determine whether the calcium ions in the purified dissolving-solution is purified completely according to the concentration of the calcium ions, is in that except for a small amount of calcium ions contained in the lithium extraction dissolving-solution itself, most of the calcium ions are introduced by the calcium oxide and/or calcium hydroxide added during the first reaction. Moreover, it is possible to indirectly judge whether other impurities in the lithium-extraction dissolving-solution are completely removed by judging the concentration of the calcium ions, thereby ensuring a purification effect and ensuring that a concentration of the fluoride ions and a concentration of the calcium ions in a purified lithium-extraction dissolving-solution are below 10 mg/L, and concentrations of other impurity ions are close to or equal to 0.

A purification method for a lithium-extraction dissolving-solution of an aluminum electrolysis waste is provided according to an embodiment in a second aspect of the disclosure, and the method includes:
Step S21, adding an alkaline mixture into the lithium-extraction dissolving-solution until a pH of the lithium-extraction dissolving-solution reaches a first target pH and performing a first reaction in the lithium-extraction dissolving-solution, and then filtering the lithium-extraction dissolving-solution to obtain a first filtrate and a first filter residue, respectively;
Step S22, adding a decalcification agent and a catalyst into the first filtrate until a pH of the first filtrate reaches a second target pH and performing a second reaction in the first filtrate, and then filtering the first filtrate to obtain a purified dissolving-solution and a second filter residue, respectively; and
Step S23, washing the first filter residue and the second filter residue by adding a washing liquid into the first filter residue and the second filter residue to form a washing slurry, and then filtering the washing slurry to obtain a washing filtrate, and returning the washing filtrate into the lithium-extraction dissolving-solution for a treatment.

The first filter residue and second filter residue obtained by the first reaction and the second reaction are washed with a washing liquid to form a washing slurry and then the washing slurry which is formed by the washing liquid through washing the first filter residue and the second filter residue is filtered to obtain the washing filtrate, and the washing filtrate is returned into the lithium-extraction dissolving-solution for a treatment, thereby effectively recovering lithium elements in the first filter residue and the second filter residue, so that there is basically no loss of lithium during a purification process.

In some embodiments, a liquid-solid ratio of the washing liquid to the first filter residue and/or the second filter residue during the washing is 3:1 to 4:1; and/or the number of times for the washing is 1 time˜2 times.

A washing effect can be ensured by controlling the liquid-solid ratio and the number of times for the washing; the lithium ions in the first filter residue and the second filter residue are washed away to obtain pure first filter residue and second filter residue, and the washing filtrate is returned for a treatment, thereby ensuring that there is basically no loss of lithium during the purification process.

In some embodiments, the method further comprises:

S24, determining, according to a concentration of the calcium ions in the purified dissolving-solution, whether the purified dissolving-solution needs to be purified for a second time.

The method according to the second aspect of the disclosure is different from the method according to the first aspect of the disclosure in that a first filter residue and a second filter residue are obtained and the first filter residue and the second filter residue are processed. The treatment for the first filtrate and the second filtrate in this method is the same as the treatment of the method described in the first aspect, and therefore will not be described in detail. Since the purification method for the lithium-extraction dissolving-solution of the aluminum electrolysis waste adopts a portion of technical solutions of the above-mentioned embodiments, it at least has all the advantageous effects brought by the technical solutions of the above-mentioned embodiments, which will not be described in detail here.

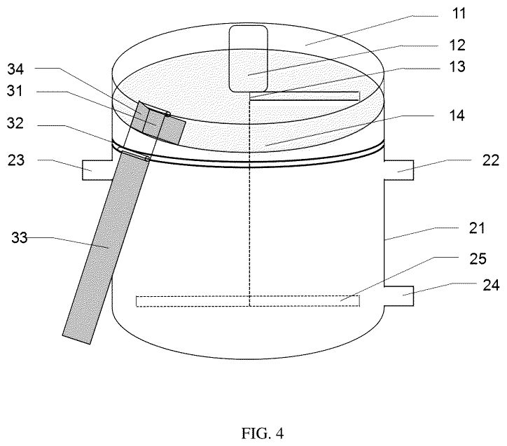

As shown in FIG. 4, a purification system for an lithium-extraction dissolving-solution of an aluminum electrolysis waste is further provided according to embodiments in a third aspect of the disclosure, the system being adapted to the above method based on a general inventive concept, the system including at least two purification devices, the purification device including:
a filter unit 1, which includes a liquid-reception tray 11, a stir motor 12, a scraper 13 and a filter screen 14; the filter screen 14 is disposed at a bottom surface of the liquid-reception tray 11; an output end of the stir motor 12 is connected to the scraper 13, and the scraper 13 is disposed above the filter screen 14;
a liquid-reception unit 2, which includes a liquid-reception tank 21, a vacuum interface 22, a feed port 23, a discharge port 24 and a stir paddle 25; the liquid-reception tank 21 is disposed directly below the filter screen 14; the feed port 23 and the discharge port 24 are respectively distributed on two sides of the liquid-reception tank 21, and the vacuum interface 22 and the discharge port 24 are disposed on a same side of the liquid-reception tank 21; the stir paddle 25 is disposed in the liquid-reception tank 21, and the stir paddle 25 is fixedly connected to an extended end of the stir motor 12.

The purification device includes: a filtration unit 1, including a liquid-reception tray 11, a stir motor 12, a scraper 13 and a filter screen 14; and a liquid-reception unit 2, including a liquid-reception tank 21, a vacuum interface 22, a feed port 23, a discharge port 24 and a stir paddle 25. Therefore, a two-step filtration can be achieved through the filtration unit 1, and filtrates after each filtration are stored through the liquid-reception unit 2 to facilitate subsequent processing, thereby obtaining a pure lithium-extraction dissolving-solution.

The system is implemented based on the above method, and steps of the method can refer to the above embodiments. Since the purification system for the lithium-extraction dissolving-solution from the aluminum electrolysis waste adopts a portion of or all technical solutions of the above-mentioned embodiments, it at least has all the advantageous effects brought by the technical solutions of the above-mentioned embodiments, which will not be not be described in detail here.

In some embodiments, the purification system further includes:
a residue discharge unit 3, which includes a shovel truck 31, a shovel-truck lane 32, and a filter residue groove 33. The shovel-truck lane 32 is disposed at an upper portion of the liquid-reception tank 21, and is located below the filter screen 14, and is disposed around an open end of the liquid-reception tank 21. The shovel truck 31 slides in the shovel-truck lane 32 to remove filter residues filtered by the filter screen 14, and the filter residue groove 33 is disposed at a side of the liquid-reception tank 21.

In an embodiment of the disclosure, the residue discharge unit 3 including the shovel truck 31, the shovel-truck lane 32, the filter residue groove 33 and a shovel-truck baffle 34 is introduced, such that the residue discharge unit 3 can cooperate with the scraper 13 to scrape a first filter residue and a second filter residue remaining in a filtration stage to an edge of the filter screen 14 through the scraper 13, and the shovel truck 31 with its own motor slides in the shovel-truck lane 32, so that the shovel truck 31 acts as a scraping shovel, thereby ensuring that the filter residue falls into the filter residue groove 33 to be discharged.

In some embodiments, in order to ensure a scraping effect of the shovel truck 31, a shovel-truck baffle 34 is disposed on the shovel truck 31 and is located at a position opposite to a direction of rotation movement of the shovel truck 31, so that the filter residues is gathered on a surface of the shovel truck 31 as the shovel truck 31 moves, and after the shovel truck 31 rotates to a corresponding position at the filter residue groove 33, the filter residues can easily fall into the filter residue groove 33.

The technical solutions of the disclosure are further described below in conjunction with some embodiments. It should be understood that these examples are only used to illustrate the disclosure and are not intended to limit a scope sought by the disclosure. Experimental methods without specifying conditions in the following examples are typically performed in accordance with national standards in China. If there are no corresponding national standards in China, general international standards, conventional conditions, or conditions recommended by the manufacturer shall be followed.

### Example 1

First, a calcium sulfate as a stabilizer with an addition amount of 6 kg/m³ is added into a lithium-extraction dissolving-solution, and then a calcium oxide is added into the lithium-extraction dissolving-solution to adjust a pH of the lithium-extraction dissolving-solution to 11 so as to remove fluoride ions, iron ions, aluminum ions, boron ions, silicon ions, manganese ions, nickel ions, copper ions and a portion of magnesium ions in the lithium-extraction dissolving-solution. A reaction caused by adding the calcium sulfate and calcium oxide can be performed in a purification device for a lithium-extraction dissolving-solution, and steps of which are that:
the lithium-extraction dissolving-solution is added into the liquid-reception tank 21 of the purification device; the vacuum interface 22 and the discharge port 24 are closed; and the stir motor 12 is turned on to drive the stir paddle 25 to rotate. After the feed port 23 is opened to add the calcium sulfate, the calcium oxide is added into the lithium-extraction dissolving-solution to adjust the pH of the lithium-extraction dissolving-solution to 11, and a first reaction is performed in the lithium-extraction dissolving-solution. A time of the first reaction is 60 minutes. A slurry after the first reaction is introduced into a liquid-reception tray 11 of another purification device; the discharge port 24 of the liquid-reception tank 21 is closed; a vacuum device connected to the vacuum interface 22 is turned on, and the feed port 23 is closed to ensure that the liquid-reception tank 21 is in a negative pressure state. The stir motor 12 is turned on to drive the scraper 13 to rotate, and thus filter residues filtered out from the filter screen 14 are continuously pushed to an edge of the liquid-reception tray 11; the residue discharge unit 3 is turned on, and the shovel truck 31 and the shovel-truck baffle 34 are operated along the shovel-truck lane 32 to shovel the filter residues at the edge of the liquid-reception tray 11, and after the shovel truck 31 operates for one circle, the filter residues are poured into the filter residue groove 33 for discharge. After a filtration is completed, a first filtrate and a first filter residue are obtained. A concentration of ions in the first filtrate is measured. At this time, a concentration of the fluoride ions is less than 10 mg/L, and concentrations of the iron ions, the aluminum ions, the boron ions, the silicon ions, the manganese ions, the nickel ions, the copper ions and so on are all close to or equal to 0.

The vacuum device is turned off and the vacuum interface 22 is closed, and the feed port 23 is opened; the sodium carbonate the amount of which is 1.5 times a theoretical value is added into the liquid-reception tank 21; the stir motor 12 is turned on to drive the stir paddle 25 to rotate for a reaction for 30 minutes, and then a sodium hydroxide is added with an addition amount of 0.2 kg/m³ to adjust a pH of the first filtrate to 11.5 for a reaction for 30 minutes. The discharge port 24 is opened to introduce a liquid in the liquid-reception tank 21 into next purification device to repeat operations so as to obtain a second filtrate and a second filter residue; and concentrations of ions in the second filtrate are measured, that is, a concentration of the calcium ions in the second filtrate is lower than 10 mg/L, a concentration of the fluoride ions in the second filtrate is lower than 10 mg/L, and concentrations of the iron ions, aluminum ions, boron ions, silicon ions, manganese ions, nickel ions, copper ions and so on are all close to or equal to 0; there is basically no loss of lithium ions, and a purified dissolving-solution is obtained.

If the concentration of the calcium ions in the second filtrate is higher than 50 mg/L, the sodium carbonate the amount of which is 1.5 times the theoretical value is added into the second filtrate for removal, so that the concentration of the calcium ions in the second filtrate is reduced to be below 10 mg/L; if the concentration of the calcium ions in the second filtrate is between 10 mg/L and 50 mg/L, the second filtrate is passed into a resin purification device, and the calcium ions in the second filtrate are further removed by ion exchange, so that the concentration of the calcium ions in the second filtrate is reduced to be below 10 mg/L, and the purified dissolving-solution is obtained.

A washing liquid, which has a liquid-solid ratio of 3:1 to the first filter residue and the second filter residue, is used to wash the first filter residue and the second filter residue for 2 times and then is filtered to obtain a washing filtrate, and the washing filtrate is returned to the lithium-extraction dissolving-solution for a cyclic lithium extraction.

### Example 2

Comparing Example 2 with Example 1, differences between Example 2 and Example 1 are:

First, a calcium sulfate as a stabilizer with an addition amount of 10 kg/m³ is added into a lithium-extraction dissolving-solution. Then a calcium hydroxide is added to adjust a pH of the lithium-extraction dissolving-solution to 11.5 for a reaction for 30 minutes, and then the lithium-extraction dissolving-solution is filtered to obtain a first filtrate. A sodium carbonate the amount of which is 3.0 times a theoretical value is added into the first filtrate to react for 20 minutes, and then a sodium hydroxide with an addition amount of 0.5 kg/m³ is added to adjust the pH of the first filtrate to 12 for a reaction for 20 minutes, and then the first filtrate is filtered to obtain a purified dissolving-solution.

A washing liquid, which has a liquid-solid ratio of 4:1 to the first filter residue and the second filter residue, is used to wash the first filter residue and the second filter residue for 2 times and then is filtered to obtain a washing filtrate, and the washing filtrate is returned to the lithium-extraction dissolving-solution for a cyclic lithium extraction.

### Example 3

Comparing Example 3 with Example 1, differences between Example 3 and Example 1 are:

First, a calcium sulfate as a stabilizer with an addition amount of 8 kg/m³ is added to a lithium-extraction dissolving-solution. Then a calcium hydroxide is added to adjust a pH of the lithium-extraction dissolving-solution to 11.3 for a reaction for 45 minutes, and then the lithium-extraction dissolving-solution is filtered to obtain a first filtrate. A sodium carbonate the amount of which is 2.2 times a theoretical value is added into the first filtrate to react for 25 minutes, and then a sodium hydroxide with an addition amount of 0.35 kg/m³ is added to adjust the pH of the first filtrate to 11.8 for a reaction for 25 minutes, and then the first filtrate is filtered to obtain a purified dissolving-solution.

A washing liquid, which has a liquid-solid ratio of 4:1 to the first filter residue and the second filter residue, is used to wash the first filter residue and the second filter residue for 1 time and then is filtered to obtain a washing filtrate, and the washing filtrate is returned to the lithium-extraction dissolving-solution for a cyclic lithium extraction.

### Related Data and Results

The purified dissolving-solution obtained in Example 1 was tested, and results are shown in Table 1.

Table 1 ion contents in the purified dissolving-solution

| | ion contents in the purified dissolving-solution, mg/L | | | | | | | | | | | |
|---|---|---|---|---|---|---|---|---|---|---|---|---|
| item | F | Ca | Li | Na | Fe | Cu | Ni | B | Mn | Mg | Si | Al |
| lithium- | 1996 | 1332.7 | 2562.0 | 9870.0 | 110.5 | 1.9 | 36.5 | 8.4 | 3.8 | 35.3 | 128.2 | 816.7 |
| extraction | | | | | | | | | | | | |
| dissolving- | | | | | | | | | | | | |
| solution 1 | | | | | | | | | | | | |
| purified | 8.5 | 7.5 | 2538.0 | 10730.0 | 0.0 | 0.021 | 0.0 | 0.02 | 0.0 | 0.0 | 0.0 | 0.0 |
| dissolving- | | | | | | | | | | | | |
| solution 1 | | | | | | | | | | | | |
| lithium- | 2065 | 216.8 | 3071.0 | 8786.7 | 131.3 | 0.0 | 36.7 | 0.0 | 2.3 | 5.3 | 211.4 | 1163.0 |
| extraction | | | | | | | | | | | | |
| dissolving- | | | | | | | | | | | | |
| solution 2 | | | | | | | | | | | | |
| purified | 9.1 | 8.2 | 3050.3 | 10106.7 | 0.012 | 0.043 | 0.015 | 0.036 | 0.0 | 0.0 | 0.0 | 0.0 |
| dissolving- | | | | | | | | | | | | |
| solution 2 | | | | | | | | | | | | |

Notes:
lithium-extraction dissolving-solution 1 and lithium-extraction dissolving-solution 2 are two groups of random parallel samples; purified dissolving-solution 1 is the purified dissolving-solution obtained from the lithium-extraction dissolving-solution 1 after being treated according to Example 1, and purified dissolving-solution 2 is the purified dissolving-solution obtained from the lithium-extraction dissolving-solution 2 after being treated according to Example 1.

According to one or more technical solutions of the embodiments of the disclosure, at least the following technical effects or advantages are achieved:

(1) A purification method for a lithium-extraction dissolving-solution of an aluminum electrolysis waste is provided according to some embodiments of the disclosure. Under a premise of ensuring that a lithium content in the lithium-extraction dissolving-solution is basically not lost, impurity ions in the lithium-extraction dissolving-solution can be removed, so that concentrations of fluorine ions and calcium ions after purification are lower than 10 mg/L, and concentrations of iron ions, aluminum ions, boron ions, silicon ions, manganese ions, nickel ions, copper ions and so on are close to or equal to 0.

(2) A purification system for a lithium-extraction dissolving-solution of an aluminum electrolysis waste is also provided according to some embodiments of the disclosure, which can realize continuous filtration and purification reaction of the lithium-extraction dissolving-solution, simplify equipment configuration by more than 50%, and improve purification efficiency.

A purification method for a lithium-extraction dissolving-solution of an aluminum electrolysis waste is provided according to some embodiments of the disclosure, which compared with a traditional purification process for dissolving-solution, a stabilizer is first added to make a lithium in the lithium-extraction dissolving-solution exist in a form of stable, highly soluble lithium sulfate (since the lithium sulfate has a high solubility in water, 100 g of water can dissolve 25.7 g of lithium sulfate at 20° C.); then a regulator is added to adjust a pH of the lithium-extraction dissolving-solution, thereby removing fluoride ions, iron ions, aluminum ions, boron ions, silicon ions, manganese ions, nickel ions, copper ions and a portion of magnesium ions in the lithium-extraction dissolving-solution; and then a sodium carbonate and a sodium hydroxide are added to remove the calcium ions, magnesium ions and the like in the lithium-extraction dissolving-solution, thereby completing a removal of impurity ions in the lithium-extraction dissolving-solution. The pH and additions of stabilizers and catalysts are simultaneously controlled at different stages, such that it can be ensured that there is basically no loss of lithium in the lithium-extraction dissolving-solution. A concentration of the fluoride ions and a concentration of the calcium ions in a purified dissolving-solution are below 10 mg/L, and concentrations of other impurity ions are close to or equal to 0, thereby achieving comprehensive removal of impurities in the lithium-extraction dissolving-solution under a premise of essentially no loss of lithium.

Various embodiments of the present disclosure may exist in the form of a range. It should be understood that the description in the form of a range is only for convenience and simplicity and should not be understood as a hard limit to the scope of the present disclosure; therefore, the described range should be considered to have specifically disclosed all possible subranges as well as the single values within such a range. For example, a description of a range from 1 to 6 should be considered to have disclosed subranges, such as from 1 to 3, from 1 to 4, from 1 to 5, from 2 to 4, from 2 to 6, and from 3 to 6, and a single number within the stated range, such as 1, 2, 3, 4, 5, and 6, which applies regardless of the range. In some embodiments, whenever a numerical range is indicated herein, it is intended to include any cited number (fractional or whole) within the indicated range.

In the disclosure, unless otherwise specified, the directional words used such as “upper” and “lower” refer to the direction of the figure in the drawing. In some embodiments, in the description of the present disclosure, the terms “including”, “comprising” and the like refer to “including but not limited to”. In the disclosure, relational terms such as “first” and “second” are merely used to distinguish one entity or operation from another and do not necessarily require or imply any such actual relationship or sequence between these entities or operations. In the disclosure, “and/or” describes the relationship between associated objects, indicating that there may be three relationships. For example, A and/or B may refer to: A alone, both A and B, and B alone. In which, A and B can be singular or plural. In the disclosure, “at least one” refers to one or more, and “plurality” refers to two or more. “At least one”, “at least one of the following” or similar expressions thereof refers to any combination of these items, including single items or any combination of plural items. For example, “at least one of a, b, or c”, or “at least one of a, b, and c” may represent: a, b, c, a˜b (that is, a and b), a˜c, b˜c, or a˜b˜c in which a, b, and c can each be single or multiple.

The above descriptions are only some embodiments of the disclosure, enabling those skilled in the art to understand or implement the disclosure. Various modifications to these embodiments will be readily apparent to those skilled in the art, and the generic principle defined in the disclosure may be practiced in other embodiments without departing from the spirit or scope of the disclosure. Therefore, the disclosure is not to be limited to the embodiments shown in the disclosure but is to be accorded the widest scope consistent with the principles and novel features claimed in the disclosure.

1. A purification method for a lithium-extraction dissolving-solution of an aluminum electrolysis waste, comprising:
adding an alkaline mixture into the lithium-extraction dissolving-solution until a pH of the lithium-extraction dissolving-solution reaches a first target pH and performing a first reaction in the lithium-extraction dissolving-solution, and then filtering the lithium-extraction dissolving-solution to obtain a first filtrate, wherein the alkaline mixture comprises a regulator and a stabilizer; the regulator is added into the lithium-extraction dissolving-solution after the stabilizer is added into the lithium-extraction dissolving-solution; the stabilizer comprises a calcium sulfate; the regulator comprises a calcium oxide and/or a calcium hydroxide; and the first target pH is 11˜11.5; and
adding a decalcification agent and a catalyst to the first filtrate until a pH of the first filtrate reaches a second target pH and performing a second reaction in the first filtrate, and then filtering the first filtrate to obtain a purified dissolving-solution, the second target pH being 11.5˜12.

2. The purification method according to claim 1, wherein an addition amount of the stabilizer makes a mass volume ratio of the stabilizer to the lithium-extraction dissolving-solution to be 6 kg/m³ to 10 kg/m³; and/or
an addition amount of the regulator is an amount that makes the pH of the lithium-extraction dissolving-solution reach the first target pH.

3. The purification method according to claim 1, wherein, the decalcification agent comprises a sodium carbonate; an actual addition amount of the sodium carbonate is 1.5 to 3.0 times a theoretical addition amount of the sodium carbonate; the theoretical addition amount of the sodium carbonate is determined by a concentration of calcium ions in the first filtrate; and/or
the catalyst comprises a sodium hydroxide, an addition amount of the sodium hydroxide makes a mass volume ratio of the sodium hydroxide to the first filtrate to be 0.2 kg/m³ to 0.5 kg/m³.

4. The purification method according to claim 1, wherein, a time of the first reaction is 30 to 60 minutes after the pH of the lithium-extraction dissolving-solution reaches the first target pH; and/or
the second reaction comprises a decalcification reaction and a catalytic reaction, the decalcification reaction being performed for 20 to 30 minutes, and then the catalytic reaction being performed for 20 to 30 minutes.

5. The purification method according to claim 1, further comprising:
adding a sodium carbonate to purify the purified dissolving-solution for a second time if a concentration of calcium ions in the purified dissolving-solution is greater than 50 mg/L; and
purifying the purified dissolving-solution for the second time using a resin if the concentration of the calcium ions in the purified dissolving-solution is 10 mg/L to 50 mg/L.

6. A purification method for a lithium-extraction dissolving-solution of an aluminum electrolysis waste, comprising:
adding an alkaline mixture into the lithium-extraction dissolving-solution until a pH of the lithium-extraction dissolving-solution reaches a first target pH and performing a first reaction in the lithium-extraction dissolving-solution, and then filtering the lithium-extraction dissolving-solution to obtain a first filtrate and a first filter residue, respectively, wherein the alkaline mixture comprises a regulator and a stabilizer, and the regulator is added into the lithium-extraction dissolving-solution after the stabilizer is added into the lithium-extraction dissolving-solution; the stabilizer comprises a calcium sulfate, and the regulator comprises a calcium oxide and/or a calcium hydroxide; and the first target pH is 11˜11.5; and
adding a decalcification agent and a catalyst into the first filtrate until a pH of the first filtrate reaches a second target pH and performing a second reaction in the first filtrate, and then filtering the first filtrate to obtain a purified dissolving-solution and a second filter residue, respectively; and
washing the first filter residue and the second filter residue by adding a washing liquid into the first filter residue and the second filter residue to form a washing slurry, and then filtering the washing slurry to obtain a washing filtrate, and returning the washing filtrate into the lithium-extraction dissolving-solution for a treatment.

7. The purification method according to claim 6, wherein an addition amount of the stabilizer makes a mass volume ratio of the stabilizer to the lithium-extraction dissolving-solution to be 6 kg/m³ to 10 kg/m³; and/or
an addition amount of the regulator is an amount that makes the pH of the lithium-extraction dissolving-solution reach the first target pH.

8. The purification method according to claim 6, wherein, the decalcification agent comprises a sodium carbonate; an actual addition amount of the sodium carbonate is 1.5 to 3.0 times a theoretical addition amount of the sodium carbonate; the theoretical addition amount of the sodium carbonate is determined by a concentration of calcium ions in the first filtrate; and/or
the catalyst comprises a sodium hydroxide, an addition amount of the sodium hydroxide makes a mass volume ratio of the sodium hydroxide to the first filtrate to be 0.2 kg/m³ to 0.5 kg/m³.

9. The purification method according to claim 6, wherein, a time of the first reaction is 30 to 60 minutes after the pH of the lithium-extraction dissolving-solution reaches the first target pH; and/or
the second reaction comprises a decalcification reaction and a catalytic reaction, the decalcification reaction being performed for 20 to 30 minutes, and then the catalytic reaction being performed for 20 to 30 minutes.

10. The purification method according to claim 6, further comprising:
adding a sodium carbonate to purify the purified dissolving-solution for a second time if a concentration of calcium ions in the purified dissolving-solution is greater than 50 mg/L; and
purifying the purified dissolving-solution for the second time using a resin if the concentration of the calcium ions in the purified dissolving-solution is 10 mg/L to 50 mg/L.

11. The purification method for the lithium-extraction dissolving-solution of the aluminum electrolysis waste according to claim 6, wherein a liquid-solid ratio of the washing liquid to the first filter residue and/or the second filter residue during the washing is 3:1 to 4:1; and/or
the number of times for the washing is 1 time˜2 times.

12. A purification system for a lithium-extraction dissolving-solution of an aluminum electrolysis waste, the system being used in the method according to claim 1, the system comprising at least two purification devices, the purification devices comprising:
a filter unit (1), comprising a liquid-reception tray (11), a stir motor (12), a scraper (13) and a filter screen (14), wherein the filter screen (14) is disposed at a bottom surface of the liquid-reception tray (11); an output end of the stir motor (12) is connected to the scraper (13); and the scraper (13) is disposed above the filter screen (14); and
a liquid-reception unit (2), comprising a liquid-reception tank (21), a vacuum interface (22), a feed port (23), a discharge port (24) and a stir paddle (25), wherein the liquid-reception tank (21) is disposed directly below the filter screen (14); the feed port (23) and the discharge port (24) are respectively distributed on two sides of the liquid-reception tank (21), and the vacuum interface (22) and the discharge port (24) are disposed on a same side of the liquid-reception tank (21); the stir paddle (25) is disposed in the liquid-reception tank (21), and the stir paddle (25) is fixedly connected to an extended end of the stir motor (12).

13. The purification system according to claim 12, further comprising: a residue discharge unit (3), comprising a shovel truck (31), a shovel-truck lane (32), and a filter residue groove (33),
wherein the shovel-truck lane (32) is disposed on an upper portion of the liquid-reception tank (21), is located below the filter screen (14), and is disposed around an open end of the liquid-reception tank (21); the shovel truck (31) slides in the shovel-truck lane (32) to remove filter residues filtered by the filter screen (14); and the filter residue groove (33) is disposed on a side of the liquid-reception tank (21).

14. The purification system according to claim 13, further comprising a shovel-truck baffle (34), which is disposed on the shovel truck (31) and is located at a position opposite to a direction of rotation movement of the shovel truck (31).

15. The purification method for the lithium-extraction dissolving-solution of the aluminum electrolysis waste according to claim 7, wherein a liquid-solid ratio of the washing liquid to the first filter residue and/or the second filter residue during the washing is 3:1 to 4:1; and/or
the number of times for the washing is 1 time˜2 times.

16. The purification method for the lithium-extraction dissolving-solution of the aluminum electrolysis waste according to claim 8, wherein a liquid-solid ratio of the washing liquid to the first filter residue and/or the second filter residue during the washing is 3:1 to 4:1; and/or
the number of times for the washing is 1 time˜2 times.

17. The purification method for the lithium-extraction dissolving-solution of the aluminum electrolysis waste according to claim 9, wherein a liquid-solid ratio of the washing liquid to the first filter residue and/or the second filter residue during the washing is 3:1 to 4:1; and/or
the number of times for the washing is 1 time˜2 times.

18. The purification method for the lithium-extraction dissolving-solution of the aluminum electrolysis waste according to claim 10, wherein a liquid-solid ratio of the washing liquid to the first filter residue and/or the second filter residue during the washing is 3:1 to 4:1; and/or
the number of times for the washing is 1 time˜2 times.
